(19) United States
(12) Patent Application Publication
(10) Pub. No.: US 2012/0058236 A1
(43) Pub. Date: Mar. 8, 2012

(54) SWEETENER COMPOSITION COMPRISING HIGH SOLUBILITY FORM OF REBAUDIOSIDE A AND METHOD OF MAKING

(75) Inventors: Lawrence E. Fosdick, Troy, OH (US); John Joseph Hahn, Maple Grove, MN (US); Yauching W. Jasinski, Dayton, OH (US); Allan S. Myerson, Chicago, IL (US); Troy Allen Rhonemus, Plymouth, MN (US); Christopher Austin Tyler, Minnetonka, MN (US); Guo-Hua Zheng, Centerville, OH (US)

(73) Assignee: Cargill Incorporated, Wayzata, MN (US)

(21) Appl. No.: 13/263,392

(22) PCT Filed: Apr. 8, 2010
(86) PCT No.: PCT/US10/30370

§ 371 Date: Nov. 11, 2011

Related U.S. Application Data
(60) Provisional application No. 61/168,072, filed on Apr. 9, 2009.

(51) Int. Cl. A23L 1/236

(52) U.S. Cl. 426/548

(57) ABSTRACT

Disclosed are sweetener compositions comprising rebaudioside A and methods of making the sweetener compositions. The sweetener compositions comprise a highly soluble crystal form of rebaudioside A that displays, in some embodiments, a solubility at 24° C. in water of about 25 (grams rebaudioside A/per 100 grams water) or greater. The high solubility of the sweetener composition of the invention allows it to be used in applications such as syrups and concentrates.

### CROSS-REFERENCE TO RELATED APPLICATIONS

This application claims the benefit of U.S. Provisional Application Ser. No. 61/168,072, filed Apr. 9, 2009, the disclosure of which is incorporated herein by reference.

### BACKGROUND

A form of rebaudioside A useful as a sweetener may be produced by crystallizing rebaudioside A from a mixture of steviol glycosides that are dissolved in an alcohol/water mixture. When the crystallization takes place in a solution that is low in water content (e.g., under 50%), followed by filtration and drying, a crystal form of rebaudioside A is obtained having an X-ray diffraction pattern substantially as shown in FIG. 1. This form is designated herein as “Form 1” of rebaudioside A. This form has high solubility in water, but contains residual solvent that is difficult to remove. However, if the crystallization of rebaudioside A is performed in a pure water or a high water content solution, or if crystals of Form 1 are slurried in water at room temperature, a second crystal form of rebaudioside A is obtained. This form is believed to be a hydrated crystal form of rebaudioside A containing 4 molecules of water per molecule of rebaudioside A. This form is characterized as being low in residual solvent and having a low solubility in water. An X-ray diffraction pattern of this form is shown in FIG. 2. Form 2 of rebaudioside A typically has a fairly low solubility when dissolved in water. For example, the solubility of the Form 2 at 24° C. is typically about 1 gram rebaudioside A/100 grams water or less. Form 1 and Form 2 will be designated herein as “standard crystal forms” of rebaudioside A.

In some sweetening applications it is desirable to provide a sweetener composition of rebaudioside A that has a higher solubility in water than Form 2. While it is possible to produce solutions with high solubility using Form 1, a solution produced from Form 1 crystals containing more than about 1 g/100 g water tends to convert to Form 2 within hours to days, leaving about 1 g/100 g water in solution. Increased solubility in water allows more of the sweetener to be dissolved in a food product in order to provide the desired sweetness level. Increased solubility may be desirable in food products such as syrups and concentrates.

In view of the foregoing what is desired is a highly pure form of rebaudioside A that has a high solubility in water, remains in solution for at least several days, and is low in residual solvent.

### SUMMARY

The invention relates to sweetener compositions comprising rebaudioside A and to methods of making the sweetener compositions. The sweetener compositions of the invention comprise a highly soluble crystal form of rebaudioside A, for example, that displays a solubility at 24° C. in water of about 25 (grams rebaudioside A/per 100 grams water) or greater. Typically, for example, the rebaudioside A has a solubility at 24° C. in water ranging from about 30 (grams rebaudioside A/100 grams water) or greater, for example, about 30 to about 45 (grams rebaudioside A/100 grams water). In many embodiments, the highly soluble form of rebaudioside A is free or substantially free of any organic solvent. The high solubility of the sweetener composition of the invention allows it to be used in applications such as syrups and concentrates.

In some embodiments, the high solubility rebaudioside A component of the sweetener composition of the invention displays a powder X-ray diffraction pattern that is substantially similar to FIG. 6. For example, the X-ray diffraction pattern may display two or more of the peaks that are characteristic of the rebaudioside A composition of FIG. 6. More typically, the X-ray diffraction pattern displays three or more, four or more, five or more, or all six of the peaks that are characteristic of the X-ray diffraction pattern of FIG. 6. Examples of characteristic peaks include those listed below.

Peak Position
(2Θ)
(λ = 1.54 Å)
4.4 ± 0.2
6.4 ± 0.2
7.4 ± 0.2
8.7 ± 0.2
12.6 ± 0.2
14.7 ± 0.2

In another aspect, the invention relates to a method of making a rebaudioside A composition comprising the steps of: (a) providing a rebaudioside A composition in a standard crystal form (Form 1 or Form 2) or in amorphous form; and (b) converting at least a portion of the rebaudioside A composition into a high solubility crystal form (Form 3). Typically, the rebaudioside A composition comprises about 90% wt. or greater rebaudioside A, or about 95% wt. or greater rebaudioside A.

In an exemplary process, the process of converting the standard crystal form into the high solubility crystal form (Form 3) comprises a ripening process. Ripening typically comprises heating a rebaudioside A composition in the presence of water at a temperature and for a time period sufficient to convert at least a portion of the rebaudioside A composition into a lower hydrate (e.g., a trihydrate) of rebaudioside A.

Other processes may also be used to convert a rebaudioside A composition into a high solubility crystal form (Form 3). For example, a rebaudioside A composition may be treated at temperatures above about 90° C. under pressure sufficient to prevent boiling. Typically, the temperature may range from about 90° C. to about 200° C. at a pressure ranging from about 0.7 to about 15 bar. Heating time may vary, for example, from about 30 minutes to 24 hours. In another process, a high solubility crystal form may be crystallized from a solution of water by evaporative crystallization, for example, at a pressure ranging from about 0.3 bar at 70° C. to about 15 bar at 200° C. In yet another process, the high solubility crystal form may be crystallized from a dilute alcohol solvent (e.g., about 20% wt. alcohol or less). This would enable bringing a wet cake from crystallization in ethanol directly into a ripening process to produce Form 3.

In yet another aspect, the invention relates to food products that comprise a sweetener composition of the invention comprising a high solubility rebaudioside A composition. Representative examples of food products include beverages (e.g., soda), syrups (i.e., water-based solutions comprising a sweetener composition of the invention), and concentrates.

### BRIEF DESCRIPTION OF THE FIGURES

FIG. 1 is a powder X-ray diffraction pattern of Form 1.

FIG. 2 is a DSC pattern of Form 1.

FIG. 3 is a powder XRD pattern of Form 1 after drying at 85° C. for 17 days.

FIG. 4 is a powder X-ray diffraction pattern of Form 2.

FIG. 5 is a DSC pattern of Form 2.

FIG. 6 is a powder X-ray diffraction pattern of Form 3.

FIG. 7 is a DSC pattern of Form 3.

FIG. 8 is a schematic diagram of a ripening process according to the invention.

### DETAILED DESCRIPTION

In the following description, reference is made to specific embodiments in which the invention may be practiced. It is to be understood that other embodiments may be utilized as changes may be made without departing from the scope of the present invention.

The invention relates to sweetener compositions and to methods of making sweetener compositions. The sweetener compositions of the invention comprise a novel crystal form of the compound rebaudioside A. The novel crystal form of rebaudioside A is characterized by having a high solubility in water as compared to prior crystal forms of rebaudioside A. In many embodiments, the novel crystal foam of the invention contains no organic solvent. The high water solubility is desirable for certain sweetening applications including, for example, beverages (e.g., sodas), syrups, and concentrates.

As noted above, the rebaudioside A crystal form of the invention is characterized by the crystals having a high solubility in water. For example, in many embodiments, the solubility of the rebaudioside A has a solubility in water at 24° C. of about 25 (grams rebaudioside A/100 grams water) or greater, for example, typically ranging from about 30 to about 45 (grams rebaudioside A/100 grams water) at 24° C. Solubility in water may be determined as described in Examples 1-2 herein.

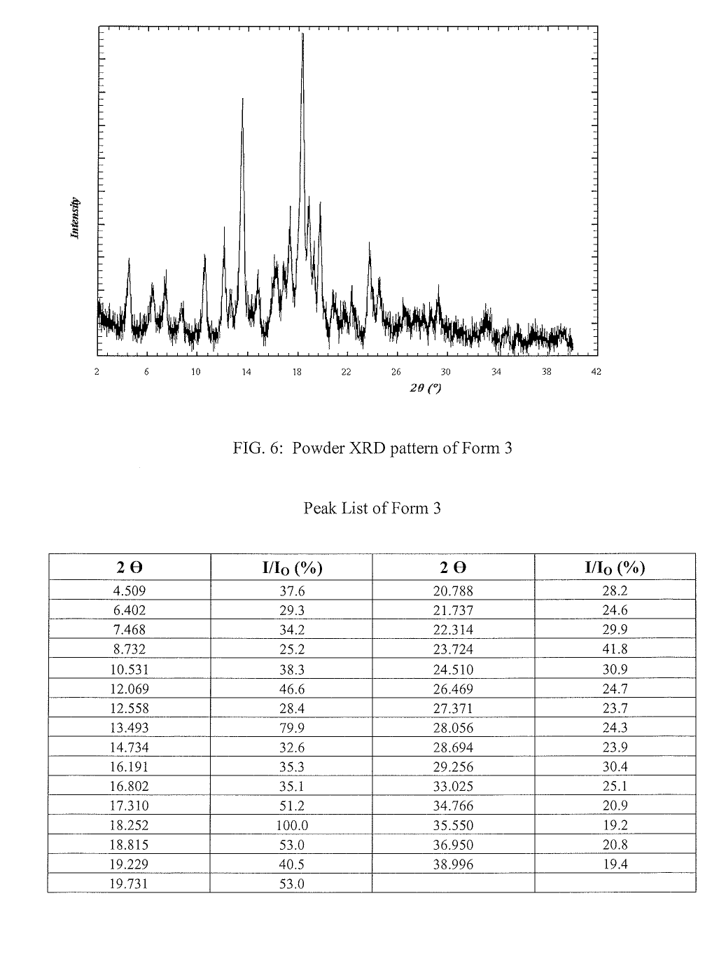

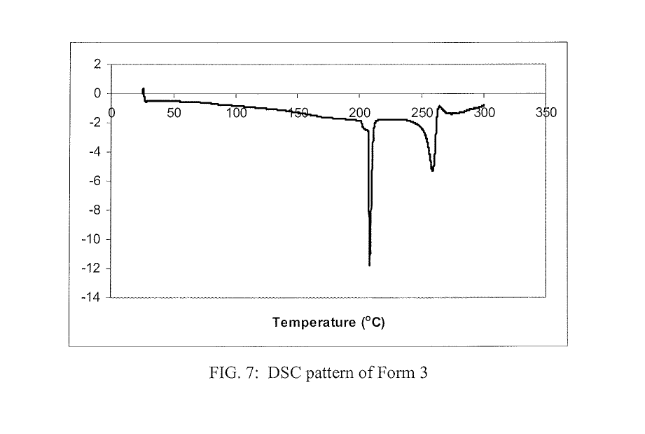

In many embodiments, the rebaudioside A crystal form of the invention is characterized in having a powder X-ray diffraction pattern that is substantially similar to the X-ray diffraction pattern shown in FIG. 6. By substantially similar it is meant that the X-ray diffraction pattern of the rebaudioside A crystal form displays a pattern of peaks that is similar in peak position and intensity such that one of skill in the art of X-ray diffraction pattern interpretation would conclude that the compounds have the same composition and crystal structure.

In many embodiments, the crystalline structure of rebaudioside A (i.e., “high solubility crystal form”) is characterized in displaying two or more characteristic X-ray diffraction peaks as identified in TABLE 1. The peaks in TABLE 1 are characteristic of the high solubility crystal form as compared to other crystal forms of rebaudioside A such as the standard crystal form. In many embodiments, the X-ray diffraction pattern contains three or more of the characteristic peaks, for example, 4 or more, 5 or more, or all 6 of the characteristic peaks.

TABLE 1
Characteristic X-ray Diffraction Peaks

| Peak Position | |
|---|---|
| (2Θ) | Intensity |
| (λ = 1.54 Å) | I/Io (%) |
| 4.4 ± 0.2 | 25 |
| 6.4 ± 0.2 | 18 |
| 7.4 ± 0.2 | 18 |
| 8.7 ± 0.2 | 13 |
| 12.6 ± 0.2 | 24 |
| 14.7 ± 0.2 | 36 |

As noted in TABLE 1, the characteristic peaks typically have a peak position that varies about +/−0.2. For example, the presence of a peak at 4.4 may be satisfied by the presence of a peak in the range of 4.2 to 4.6.

An X-ray diffraction pattern of the rebaudioside A compositions of the invention may be obtained using techniques known in the art for the characterization of organic compounds using X-ray diffraction techniques. Examples of radiation sources include CuK and synchrotron radiation. To prepare an X-ray diffraction pattern, a sample of the composition is typically ground into a fine powder using a using a mortar and pestle or other grinding apparatus. The fine powder is then packed into an aluminum sample holder with a zero background silicon plate. The powder X-ray diffraction pattern of the composition can then be obtained, for example, using a Rigaku Miniflex diffractometer with CuK radiation (λ=1.54 Å). Typical conditions include scanning at a scan speed of about 0.2 to 0.3 (° C./minute).

The high solubility crystal form of rebaudioside A of the invention can be prepared, for example, by first preparing rebaudioside A in a previously known crystal form having a lower solubility in water (e.g., Form 2), and then converting the rebaudioside A in Form 2 to the high solubility crystal form of the invention (“high solubility crystal form”) by a ripening process. In another embodiment, the starting material may comprise a standard solvated form (e.g., Form 1) which may be ripened to provide the high solubility crystal form of the invention. In yet another embodiment, an amorphous form of rebaudioside A may be converted to the high solubility crystal form of the invention.

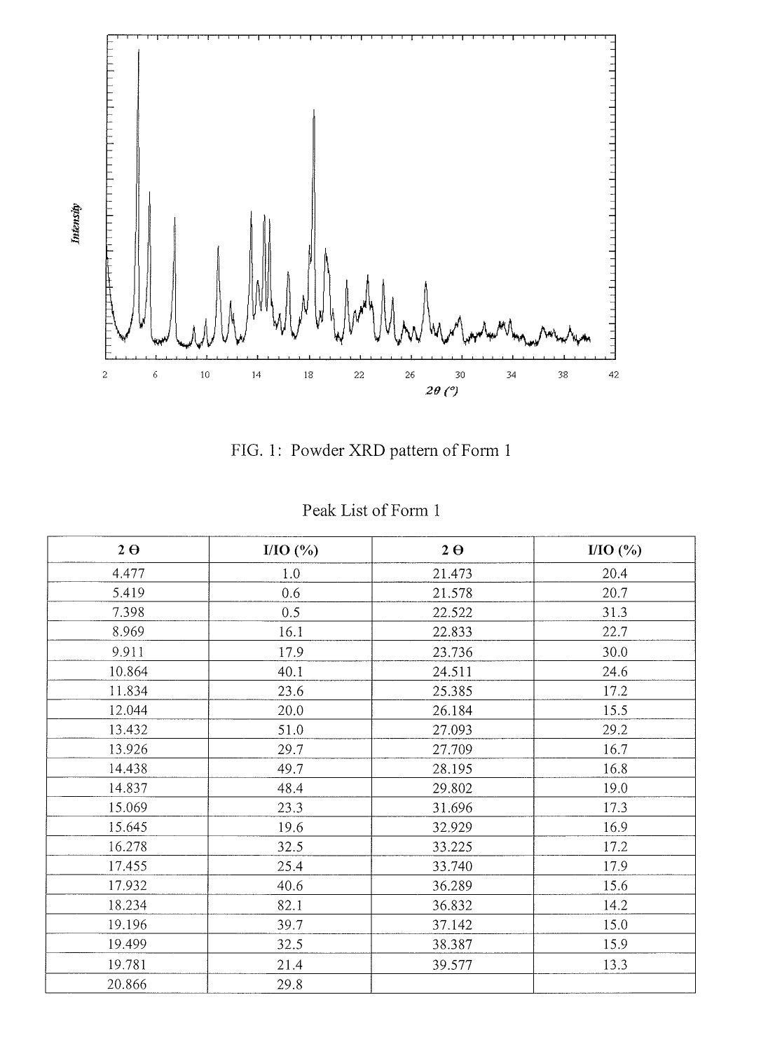

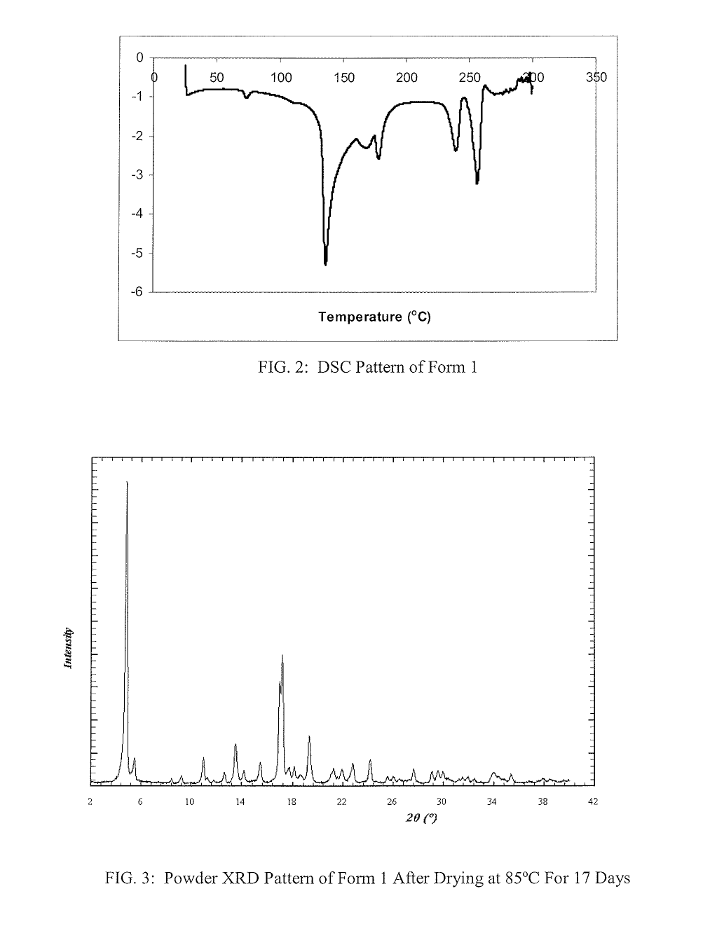

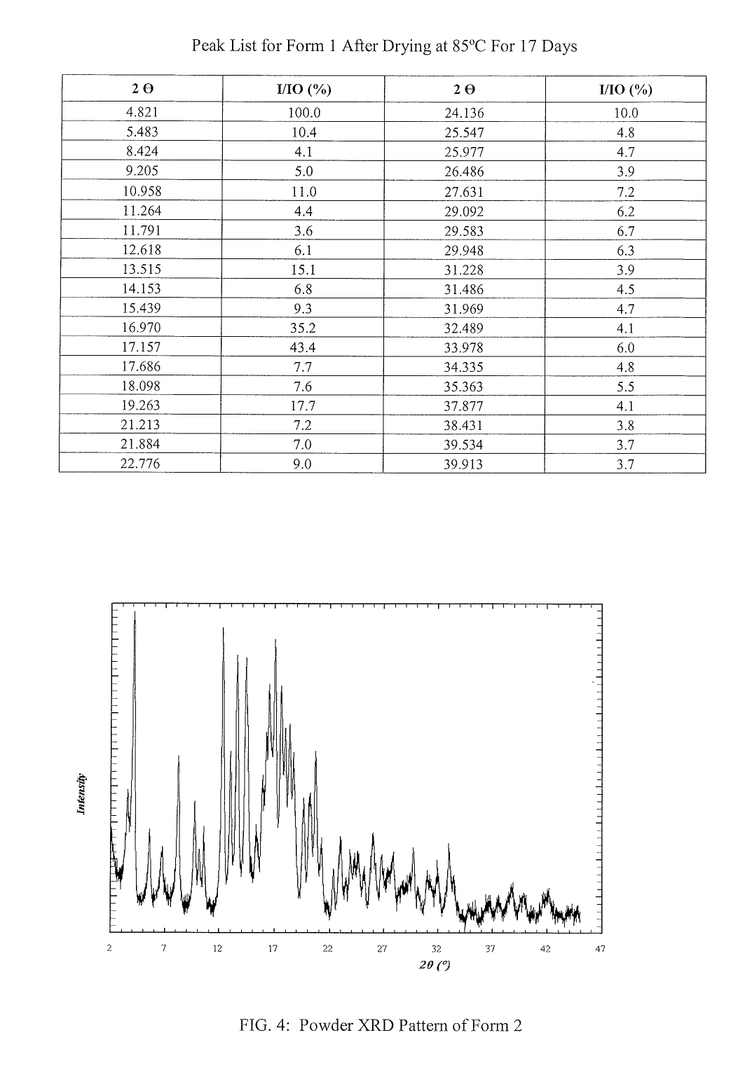

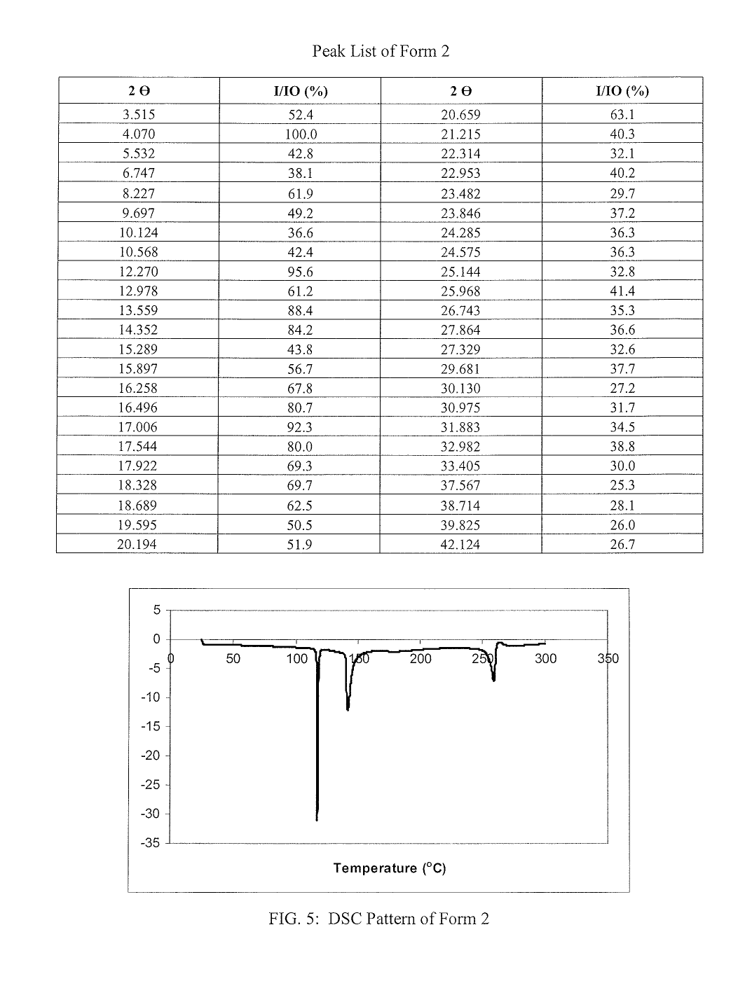

As a starting material for the method of the invention, rebaudioside A crystals in Form 1 may be prepared, for example, by crystallizing rebaudioside A from an alcohol/water solvent mixture (e.g., 85% ethanol/15% water). The resulting rebaudioside A crystal of Form 1 and has an X-ray diffraction spectra similar to that shown in FIG. 1. Typically, the rebaudioside A starting material has a purity of rebaudioside A ranging from about 90% wt. or greater or about 95% wt. or greater. In some embodiments the purity ranges from about 95% wt. to about 99.9% wt. rebaudioside A. Other materials in the composition include, for example, rebaudioside B, rebaudioside C, rebaudioside D, rebaudioside F, stevioside, dulcoside, and steviolbioside. Typically, the non-rebaudioside A components are present in an amount ranging from about 0.1 to about 5% wt.

As a starting material, rebaudioside A in Form 2 may also be used as a starting material for preparing the high solubility crystal form of the invention. This form may be obtained, for example, by dissolving Form 1 in water at room temperature and allowing it to recrystallize to yield Form 2. Form 2 is a much less soluble in water than Form 1.

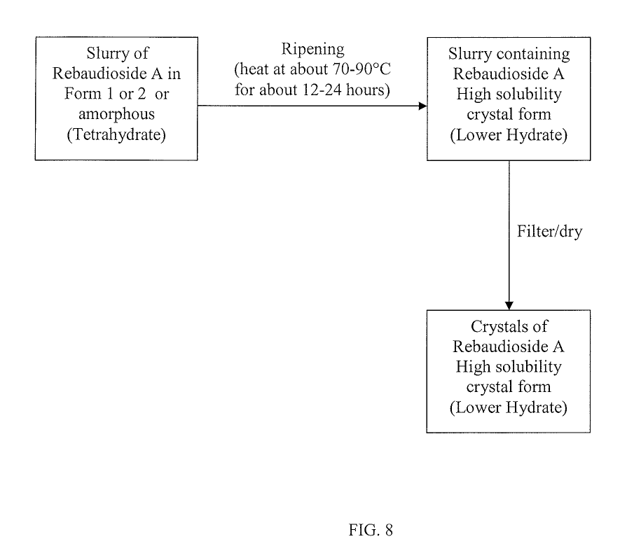

Once prepared, the rebaudioside A composition (e.g., standard crystal form (Form 1 or Form 2) or amorphous form) is treated in order to convert at least a portion of the rebaudioside A into the high solubility crystal form of the invention. In some embodiments, the rebaudioside A composition is converted into the high solubility crystal faun using a ripening process. The ripening process is conducted by exposing the rebaudioside A composition to high temperatures in the presence of water. For example, a slurry of rebaudioside A in the Form 1 or Form 2 can be prepared by mixing the crystals with water, and stirring the mixture to form a slurry. Typically the concentration or rebaudioside A in the slurry ranges from about 20% to about 50% weight. The ripening process is typically conducted at a temperature that ranges from about 70° C. to 100° C., although other temperatures may be useful. The ripening process is typically conducted for a period of time ranging from about 12 hours to about 24 hours, although other time periods may also be useful. Typically, during the ripening process, the slurry of rebaudioside A is slowly stirred or mixed while being heated. The ripening process causes at least a portion of the rebaudioside A composition to be converted into the high solubility crystal form of the invention. A schematic diagram of an exemplary embodiment of a ripening process is shown in FIG. 8.

Other processes may also be used to convert the rebaudioside A composition (e.g., standard crystal form or amorphous form) into the high solubility crystal form (Form 3). For example, to reduce processing time, rebaudioside A in a standard crystal form or amorphous form may be treated at temperatures above about 90° C. under pressure sufficient to prevent boiling. For example, the temperature may range from about 90° C. to about 200° C. at a pressure ranging from about 0.7 to about 15 bar, more preferably about 100° C. (1 bar) to about 150° C. (5 bar). Heating time may vary, for example, from about 30 minutes to 24 hours, more preferably about 1 hour to 3 hours. In another process, Form 3 may be crystallized directly from a solution of water or dilute alcohol (e.g., about 20% wt alcohol or less) by evaporative crystallization at a pressure ranging from about 0.3 bar at 70° C. to about 15 bar at 200° C., more preferably 100° C. (1 bar) to 150° C. (5 bar). In yet another process, the high solubility crystal form may be produced by ripening in a dilute alcohol (e.g., about 20% wt. alcohol or less). This would enable bringing a wet cake from crystallization in ethanol directly into a conversion process to produce Form 3.

After converting, the resulting high solubility crystal form may be recovered by conventional filtration process, for example, using a Büchner funnel. In a production environment recovery may take place, for example, by centrifugation, pannevis filtration, nutch, rosenmund, and the like. The recovered product can be dried by exposure to a nitrogen stream and/or exposure to heat and/or vacuum (e.g., a vacuum oven).

Although not wishing to be bound by theory, it is believed that the conversion process (e.g., ripening process) converts Form 1, which is believed to be an ethanol solvate of rebaudioside A, or Form 2 which is believed to be a tetrahydrate (i.e., reb A.4H₂O), into a high solubility crystal form, which is believed to be a lower hydrate (e.g., a trihydrate) of rebaudioside A. As used herein the term “lower hydrate” refers to a rebaudioside A crystal form that has less than four associated water molecules per molecule or rebaudioside A. Examples of lower hydrates include trihydrates (rebA.3H₂O), dihydrates (rebA.2H₂O), and monohydrates (rebA.H₂O). Non-stoichiometric hydrates are also possible. The conversion of the tetrahydrate or ethanol solvate to a lower hydrate results in an increase in the solubility of the rebaudioside A. Typically, the high solubility rebaudioside A of the invention has a solubility in water at 24° C. of about 25 (grams rebaudioside A/100 grams water) or greater, for example, typically ranging from about 30 to about 45 (grams rebaudioside A/100 grams water) at 24° C.

The invention will now be described with reference to the following non-limiting Examples.

### EXAMPLES

DSC Analysis: Calorimetric measurements were performed with a Mettler Toledo DSC 822e. Samples of 4-6 mg were weighted and sealed into 404 μL aluminum pans. DSC runs were conducted over a temperature range of 25° C. to 300° C. at a rate of 10° C./min.

X-ray Diffraction: Powder X-ray diffraction patterns were obtained using a Rigaku Miniflex diffractometer with CuK radiation (λ=1.54 Å) at a scan speed of 0.2 to 0.3 (° C./minute).

### Example 1

Determination of Aqueous Solubility (Room Temperature) of Oven Dried Solid Obtained From Ripening of Standard Form at High Temperature in Water

10 mg of sample was mixed with 0.5 mL deionized water and stirred by a magnetic stirrer at room temperature. As the solid was completely dissolved, more solid was added to the system with the increments of 10-40 mg until the solution became cloudy, which corresponded to the final concentration of 0.41 g/mL. The cloudy solution was filtered through a Millex-GV 0.22 um filter into a pre-weighted aluminum pan and the known mass of clear filtered solution was placed into an oven at 85° C. The solvent was completely evaporated and the residual solid was weighted to determine solubility. The results of the testing are shown below.

TABLE 2

| | Weight of Solid | |
|---|---|---|
| Initial Weight of | Residual After | Solubility at 24° C. |
| Filtered Solution | Evaporation | (grams/100 grams |
| (mg) | (mg) | water) |
| 306.4 | 86.2 | 39.146 |
| 132.6 | 38 | 40.169 |

### Example 2

Determination of Aqueous Solubility (Room Temperature) of Dry Solid Obtained From Ripening of Water-Form at High Temperature with Starting Concentration of 1.5 g/mL.

16 mg of sample was mixed with 1 mL deionized water and was stirred by a magnetic stirrer at room temperature. As the solid was completely dissolved, more solid was added to the system with the increments of 10-40 mg until the solution became cloudy, which corresponded to the final concentration of 0.4 g/mL. The cloudy solution was filtered through a Millex-GV 0.22 um filter into a pre-weighted aluminum pan and the known mass of clear filtered solution was placed into an oven at 85° C. The solvent was completely evaporated and the residual solid was weighted to determine solubility. The results of the testing are shown below.

TABLE 3

| | Weight of Solid | |
|---|---|---|
| Initial Weight of | Residual After | Solubility at 24° C. |
| Filtered Solution | Evaporation | (grams/100 grams |
| (mg) | (mg) | water) |
| 316.0 | 80.1 | 33.826 |
| 236.3 | 59 | 33.277 |

TABLE 4
Solubility of Form 2 (starting material) For Comparison.

| | Weight of Solid | |
|---|---|---|
| Initial Weight of | Residual After | Solubility at 22° C. |
| Filtered Solution | Evaporation | (grams/100 grams |
| (mg) | (mg) | water) |
| 410.72 | 0.63 | 0.154 |

### Example 3

### Preparation of Rebaudioside A In Form 1

Rebaudioside A in Form 1 was prepared as follows.

Crystallization: 2.1 g of Rebaudioside A and 40 mL was added in ethanol/water (85:15%, v/v) mixture solvent and the suspension was heated (˜65° C.) and stirred with a magnetic stirrer bar on a magnetic hot plate until the material was completely dissolved. The solution was cooled down to room temperature (˜24° C.) to achieve supersaturation and, then, was aged for two days. As spontaneous crystallization did not occur, ˜0.025 g of Rebaudioside A was added to the solution. Crystals were observed inside the solution within an hour, which were then allowed to grow overnight and then filtered. The filtered sample was dried at ambient environment (˜24° C.) for 1 day.

Drying: After drying at a vacuum oven (˜85° C.) for 17 days, the XRD pattern of the sample changed, (FIG. 3) indicating the original material was solvate whose structure changed upon desolvating.

### Example 4

### Preparation Or Rebaudioside A In Form 2

Rebaudioside A in Form 2 was prepared as follows.

Crystallization: 4.0-20.0 g of Rebaudioside A and 40 mL was added in water and the suspension was heated (60-80° C.) and stirred with a magnetic stirrer bar on a magnetic hot plate until the material was completely dissolved. The solution was cooled down to room temperature (˜24° C.) to achieve supersaturation. Crystals were obtained within an hour or several days and, then, were filtered.

Drying: The filtered sample was dried at a vacuum oven (˜85° C.) for 1-14 days. The water content of the dried sample is typically about 7.0%.

### Example 5

### Preparation of Rebaudioside Form 3

Form 3 of Rebaudioside A was prepared as follows.

Procedure 1: 4.5 g of Rebaudioside A (Form 1) was added in 4 mL of water were in a vial. The suspension was stirred with a magnetic stirrer bar for couple of minutes at ˜90° C. and ˜1 g of Rebaudioside A was added to the solution to increase the concentration. After the addition of extra solid, the solution was almost solidified so 0.5 mL of water was also added to the system. The solution with final concentration of ˜1.0 g/mL was stirred continuously at ˜90° C. for 15˜20 hours. The undissolved solid was filtered immediately through a Buchner funnel while the solution was still hot. The filtered portion, which was a gel-like compound was immediately placed into a vacuum oven at 80° C. and dried for 6-10 hours.

Procedure 2: 4.0-5.0 g of Rebaudioside A (Form 2) was added in 3 mL of water in a vial. The suspension was stirred with a magnetic stirrer bar for couple of minutes at ˜90° C. and 0.5˜1 g of Rebaudioside A was added to the solution to increase the concentration. After the addition of extra solid, the solution was almost solidified so 0.5 mL of water was also added to the system. The solution with final concentration of 1.0-1.6 g/mL was stirred continuously at ˜90° C. for 15˜20 hours. The undissolved solid was filtered immediately through a Buchner funnel while the solution was still hot. The filtered portion, which was a gel-like compound was immediately placed into a vacuum oven at 80° C. and dried for 6-10 hours.

Procedure 3: ˜5.0 g of Rebaudioside A (Form 1 or Form 2) was added in 10 mL of water in a glass jar. The suspension was heated at 80˜100° C. while being stirred with a magnetic stirrer bar until the material was completely dissolved. The glass jar was opened such that water from the solution was allowed to evaporate while being stirred with a magnetic stirrer at the temperature of 90-95° C. until the crystals were produced. The crystals were dried in a vacuum oven at 90-95° C. for 24 hours.

Drying: The water content of the dried sample was always ˜2.0% immediately after drying at a vacuum oven (˜85° C.) for 14 days. However, the water content of the sample quickly increased with staying time out of a vacuum oven at room temperature (˜24° C.)

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

1-13. (canceled)

14. A sweetener composition comprising:
rebaudioside A having a crystal form having an X-ray diffraction pattern substantially as shown in FIG. 6.

15. The sweetener composition of claim 14, wherein the rebaudioside A is a lower hydrate.

16. The sweetener composition of claim 14, wherein the sweetener composition further comprises one or more of rebaudioside B, rebaudioside C, rebaudioside D, rebaudioside F, stevioside, dulcoside, and steviolbioside.

17. A sweetener composition comprising:
rebaudioside A crystal form that has an X-ray diffraction pattern containing three or more characteristic peaks selected from the following:
Peak Position
(2Θ)
(λ = 1.54 Å)
4.4 ± 0.2
6.4 ± 0.2
7.4 ± 0.2
8.7 ± 0.2
12.6 ± 0.2
14.7 ± 0.2

18. (canceled)

19. The sweetener composition of claim 17, wherein the X-ray pattern contains four or more of the characteristic peaks.

20. The sweetener composition of claim 17, wherein the X-ray pattern contains five or more of the characteristic peaks.

21. The sweetener composition of claim 17, wherein the X-ray pattern contains six characteristic peaks.

22. The sweetener composition of claim 17, wherein the rebaudioside A is a lower hydrate.

23. The sweetener composition of claim 17, wherein the sweetener composition further comprises one or more of rebaudioside B, rebaudioside C, rebaudioside D, rebaudioside F, stevioside, dulcoside, and steviolbioside.

24. A food composition comprising a sweetener composition according to claim 17.

25-27. (canceled)

28. A method of making a sweetener composition comprising rebaudioside A, the method comprising the steps of:
(a) providing a rebaudioside A composition; and
(b) converting at least a portion of the rebaudioside A composition to a high solubility crystal form having three or more characteristic peaks selected from the following:
Peak Position
(2Θ)
(λ = 1.54 Å)
4.4 ± 0.2
6.4 ± 0.2
7.4 ± 0.2
8.7 ± 0.2
12.6 ± 0.2
14.7 ± 0.2

29. The method of claim 28, wherein the rebaudioside A composition is in a standard crystal form or in an amorphous form.

30. The method of claim 29, wherein the standard crystal form is Form 1 or Form 2.

31. The method of claim 28, wherein the step of converting at least a portion of the rebaudioside A composition to a high solubility crystal form comprises the step of:
ripening the rebaudioside A composition of step (a) by heating in water at an elevated temperature for a period of time sufficient to convert at least a least a portion of the standard crystal form into a high solubility crystal form having a solubility in water at 24° C. of about 25 (grams rebaudioside A/100 grams water) or greater.

32. The method of claim 31, wherein the heating step takes place at a temperature ranging from about 70° C. to about 100° C.

33. The method of claim 31, wherein the heating step takes place for a period of about 12 to about 24 hours.

34. The method of claim 28, wherein the step of converting at least a portion of the rebaudioside A composition to a high solubility crystal form comprises the step of:
heating the rebaudioside A composition to a temperature of about 90° C. or greater in the presence of water and under pressure sufficient to prevent boiling.

35. The method of claim 34, wherein the temperature ranges from about 90° C. to about 200° C. and wherein the pressure ranges from about 0.7 bar to about 15 bar.

36. The method of claim 34, wherein the temperature and pressure range from about 100° C. at about 1 bar to about 150° C. at about 5 bar.

37. The method of claim 28, wherein the step of converting at least a portion of the rebaudioside A composition to a high solubility crystal form comprises the step of:
crystallizing a high solubility crystal form of rebaudioside A from water or dilute alcohol in water by evaporative crystallization.

38. The method of claim 37, wherein the dilute alcohol in water comprises about 20% wt. alcohol or less.

39. The method of claim 37, wherein the evaporative crystallization is conducted at a pressure ranging from about 0.3 to about 15 bar at a temperature ranging from about 70° C. to about 200° C.

40-44. (canceled)

45. The sweetener composition of claim 17, wherein the rebaudioside A crystal is a high solubility crystal form of rebaudioside A having a solubility in water at 24° C. of about 25 (grams rebaudioside A/100 grams water) or greater.

46. The sweetener composition of claim 17, wherein the rebaudioside A crystal is a high solubility crystal form of rebaudioside A having a solubility in water at 24° C. of about 30 (grams rebaudioside A/100 grams water) or greater.

47. The sweetener composition of claim 17, wherein the rebaudioside A crystal is a high solubility crystal form of rebaudioside A having a solubility in water at 24° C. of about 30 to about 45 (grams rebaudioside A/100 grams water) or greater.
